(19) United States
(12) Patent Application Publication
(10) Pub. No.: US 2025/0275580 A1
(43) Pub. Date: Sep. 4, 2025

(54) AEROSOL GENERATING DEVICE AND HEATING STRUCTURE THEREOF

(71) Applicant: SMOORE INTERNATIONAL HOLDINGS LIMITED, George Town (KY)

(72) Inventors: Lei MA, Shenzhen (CN); Hongming ZHOU, Shenzhen (CN); Rihong LI, Shenzhen (CN); Xianwu DU, Shenzhen (CN); Guo ZHANG, Shenzhen (CN)

(21) Appl. No.: 19/211,133

(22) Filed: May 16, 2025

Related U.S. Application Data
(63) Continuation of application No. PCT/CN2023/114109, filed on Aug. 21, 2023.

(30) Foreign Application Priority Data
Nov. 17, 2022 (CN) 202223061100.4

(51) Int. Cl. A24F 40/46; A24F 40/20; A24F 40/57; A24F 40/70

(52) U.S. Cl. CPC A24F 40/46; A24F 40/70; A24F 40/20; A24F 40/57

(57) ABSTRACT

A heating structure includes: a heating element; and a tube body for infrared light waves to pass through. A gap is provided between the heating element and a tube wall of the tube body. The heating element includes a heating portion arranged longitudinally for radiating the infrared light waves in a power-on state, and a conductive portion for connecting with power for the heating portion. A thickness of the tube wall of the tube body is 0.1 mm-1 mm.

### CROSS-REFERENCE TO PRIOR APPLICATION

This application is a continuation of International Patent Application No. PCT/CN2023/114109, filed on Aug. 21, 2023, which claims priority to Chinese Patent Application No. 202223061100.4, filed on Nov. 17, 2022. The entire disclosure of both applications is hereby incorporated by reference herein.

### FIELD

The present disclosure relates to the field of heat-not-burn atomization, and in particular to an aerosol generating device and a heating structure thereof.

### BACKGROUND

In related arts, an aerosol generating device is the electronic equipment used for heating an aerosol forming substrate (solid substrate such as tobacco and other plant leaf products) without burning it. Generally, the aerosol forming substrate is atomized within 350° C. The disadvantage of this heating method is that since a heating element conducts heat directly or indirectly through a solid material to the aerosol forming substrate, it requires that the working temperature of the heating element should not be too high, and otherwise it will cause the aerosol forming substrate to be overheated to influence the puffing taste of the aerosol generating device. Therefore, there is currently little research on the situation that the working temperature of the heating element is higher than 400° C.

In addition, the low temperature of the heating element directly causes the preheating time for the aerosol generating device before puffing to be longer. Currently, the preheating time for products in the market is generally over 15 seconds, which greatly affects the consumer experience.

### SUMMARY

In an embodiment, the present invention provides a heating structure, comprising: a heating element; and a tube body for infrared light waves to pass through, wherein a gap is provided between the heating element and a tube wall of the tube body, wherein the heating element comprises a heating portion arranged longitudinally and configured to radiate the infrared light waves in a power-on state, and a conductive portion configured to connect with power for the heating portion, and wherein a thickness of the tube wall of the tube body is 0.1 mm-1 mm.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a 3D schematic structural diagram of an aerosol generating device according to some embodiments of the present disclosure;

FIG. 2 is a 3D schematic structural diagram of a heating structure of the aerosol generating device in FIG. 1;

FIG. 3 is a schematic exploded structural diagram of the heating structure in FIG. 2;

FIG. 4 is a temperature change curve chart during working of the heating element in FIG. 1; and

FIG. 5 is a 3D schematic structural diagram of a heating structure according to another embodiment of the present disclosure.

### DETAILED DESCRIPTION

In an embodiment, the present invention provides an improved aerosol generating device and a heating structure.

In an embodiment, the present invention provides a heating structure that includes a heating element and a tube body for infrared light waves to pass through, where a gap is provided between the heating element and the tube wall of the tube body, the heating element includes a heating portion arranged longitudinally and configured to radiate the infrared light waves in a power-on state, and a conductive portion configured to connect with power for the heating portion, and the thickness of the tube wall of the tube body is 0.1 mm-1 mm.

In some embodiments, the heating portion includes a heating substrate for generating heat in a power-on state, and an infrared radiation layer arranged on the outer surface of the heating substrate and configured to radiate the infrared light waves.

In some embodiments, the tube body is made of quartz glass, ceramic or diamond.

In some embodiments, the heating portion is formed by winding or bending a strip-shaped or linear heating wire.

In some embodiments, the thickness range of the tube wall of the tube body is 0.15 mm-0.5 mm.

In some embodiments, the highest working temperature range of the heating element is 500° C.-1300° C.

In some embodiments, the highest working temperature range of the heating element is 800° C.-1100° C.

In some embodiments, the spacing of the gap is 0.05 mm-0.8 mm.

In some embodiments, the spacing of the gap is 0.1 mm-0.5 mm.

In some embodiments, the heating element is arranged on the inner side of the tube body, and the gap is provided between the heating element and the inner wall of the tube body.

In some embodiments, the heating portion includes a first heating portion and a second heating portion electrically connected to each other; and
the first heating portion is wound around the outer side of the second heating portion, and the gap is formed between the outer periphery of the first heating portion and the inner wall of the tube body.

In some embodiments, the second heating portion is linear; and
the first heating portion includes at least one bent section.

In some embodiments, the tube body includes a first sleeve and a second sleeve sleeved around the outer periphery of the first sleeve;
an interval is provided between the first sleeve and the second sleeve, and the interval forms an accommodating cavity for accommodating the heating element; and
the heating element is arranged on the outer periphery of the first sleeve and the gap is formed between the heating element and the outer surface of the tube wall of the first sleeve, the thickness of the tube wall is the thickness of the tube wall of the first sleeve, and a heating cavity for heating an aerosol forming substrate is formed on the inner side of the first sleeve.

The present disclosure further provides an aerosol generating device, including the heating structure described above.

The present disclosure has the following beneficial effects: In the present disclosure, the heating portion of the heating element can radiate infrared light waves in a power-on state, and the infrared light waves can pass through the tube body to reach and heat the aerosol forming substrate. In a case that the highest working temperature of the heating element reaches 1000° C. or above (the working temperature of traditional HNB heating elements generally does not exceed 400° C.), it will not cause the aerosol forming substrate to be overheated, thus greatly improving the puffing taste. At the same time, in a high-temperature working state, the preheating time is greatly reduced, thus greatly improving the consumer experience. In addition, since the thickness of the tube wall of the tube body is 0.1 mm-1 mm, by arranging the thickness of the tube wall, the spacing between the heating element and the tube wall of the tube body can be changed to ensure that as much heat as possible is generated through infrared radiation to heat and atomize the aerosol forming substrate, and the influence of the heat conduct of the heating element can also be reasonably controlled, thus achieving the effect of uniformly atomizing the aerosol forming substrate on the whole.

To provide a clearer understanding of the technical features, objectives, and effects of the present disclosure, the specific embodiments of the present disclosure will be described below with reference to the drawings.

In the description of the present disclosure, it needs to be understood that directional and positional relationships indicated by terms such as “longitudinal”, “axial”, “length”, “lower”, “inner” and “outer” are directional or positional relationships based on the drawings, or directional or positional relationships formed by commonly placing the product of the present disclosure in use, which are only for the purposes of conveniently describing the present disclosure and simplifying the description, instead of indicating or implying that the device or element referred to must have a specific orientation or be constructed and operated in a specific orientation, and cannot be understood as limitations on the present disclosure.

In addition, terms “first” and “second” are used merely for the purpose of description, and cannot be construed as indicating or implying relative importance or implying a quantity of indicated technical features. Therefore, a feature defined by “first” or “second” may explicitly indicate or implicitly include at least one of such features. In the description of the present disclosure, “multiple” means at least two, such as two or three, unless otherwise specifically defined.

In the present disclosure, unless otherwise explicitly specified and limited, the terms “mount”, “connect”, and “fix” are understood in a broad sense. For example, it may be a fixed connection, a detachable connection, or an integral connection; or it may be mechanical connection or electrical connection; or it may be direct connection, indirect connection through an intermediate medium, or internal communication between two elements or interaction relationship between two elements, unless otherwise specified explicitly. Those skilled in the art may understand the specific meanings of the terms in the present disclosure based on specific situations.

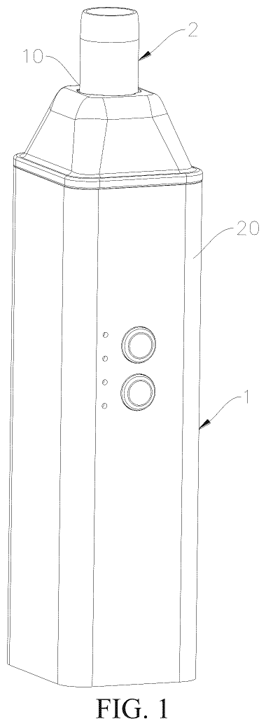

FIG. 1 shows an aerosol generating device 1 and an aerosol forming substrate 2 detachably inserted into one end of the aerosol generating device 1 in some embodiments of the present disclosure. In some embodiments, the aerosol generating device 1 may be in a square column shape for case of gripping by a user, and may be configured to perform low-temperature baking and heating on the aerosol forming substrate 2 inserted therein to release an aerosol extract from the aerosol forming substrate 2 in a non-burning state. In addition, the atomization stability is good and the puffing taste is excellent. In some embodiments, the aerosol forming substrate 2 may be cylindrical and may be a filamentous or sheetlike solid material made from leaves and/or stems of plants, and aroma components may be further added to the solid material. As can be understood, the aerosol generating device 1 is not limited to be in the square column shape. In some other embodiments, it may also in any other shape such as cylindrical shape or elliptical column shape.

In some embodiments, the aerosol generating device 1 may include a heating structure 10 and a housing 20 for carrying the heating structure 10. In some embodiments, the heating structure 10 may be cylindrical and may allow the aerosol forming substrate 2 to be detachably inserted to heat and bake the aerosol forming substrate 2. In some embodiments, the aerosol generating device 1 may further include a power supply assembly arranged in the housing 20. The heating structure 10 may be partially inserted into the aerosol forming substrate. Specifically, it may be partially inserted into a substrate section of the aerosol forming substrate, and generates thermal radiation to heat the substrate section of the aerosol forming substrate in a power-on state, causing it to be atomized to generate an aerosol. In this embodiment, the thermal radiation may be infrared radiation. The heating structure 10 has the advantages of easiness in assembling, simple structure, high atomization efficiency, strong stability, and long service life. The power supply assembly is electrically connected to the heating structure 10 to supply power to the heating structure 10.

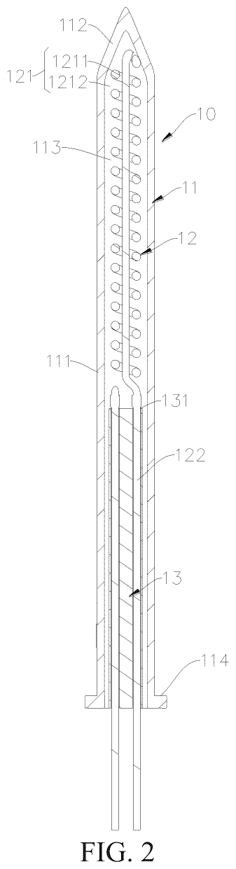

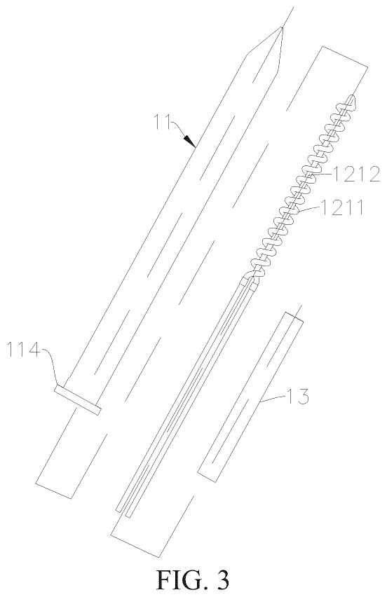

Referring to FIG. 2 to FIG. 3 together, in some embodiments, the heating structure 10 may include a tube body 11 and a heating element 12. The tube body 11 covers at least part of the heating element 12 and may allow light waves to pass through to reach the aerosol forming substrate 2. Specifically, in this embodiment, the tube body 11 may allow infrared light waves to pass through, thus facilitating the heating element 12 to radiate the infrared light waves to heat the aerosol forming substrate 2. Specifically, a gap is provided between the heating element 12 and the tube body 11. In a power-on state, the heating element 12 quickly heats to increase the temperature up to 1000° C.-1300° C. within 1 s-3 s, the surface temperature of the tube body 11 can be controlled below 350° C., and the overall atomization temperature of the aerosol forming substrate 2 is controlled at 300° C.-350° C., thus achieving precise atomization of the aerosol forming substrate 2 in a wave band of 2 μm-5 μm. The heating structure further includes an insulating sleeve 13. The insulating sleeve 13 is arranged at the lower open end of the tube body 11, and a conductive portion 122 of the heating element 12 penetrates through the insulating sleeve 13 to insulate two lead wires of the conductive portion 122 from each other.

In some embodiments, the tube body 11 may be a quartz glass tube. Of course, as can be understood, in some other embodiments, the tube body 11 is not limited to the quartz tube and may be any other window material that allows light waves to pass through, such as infrared transparent glass, transparent ceramics, or diamond. Since the tube body 11 that allows passage mainly in a wave band of 2 μm-5 μm needs to be selected for the aerosol forming substrate 2 to achieve an effect that a large amount of energy is generated through infrared radiation to atomize and absorb the aerosol forming substrate 2, the tube body 11 is made of a material such as quartz glass, transparent ceramics, or diamond to allow infrared radiation to penetrate through the aerosol forming substrate 2 to achieve uniform heating, thus maintaining temperature uniformity throughout the entire cross section of the aerosol forming substrate 2 and improving the atomization uniformity.

In some embodiments, the tube body 11 may be a hollow tube. Specifically, the tube body 11 includes a tubular body 111 with a circular cross section, and a pointed structure 112 arranged at one end of the tubular body 111. Of course, as can be understood, in some other embodiments, the cross section of the tubular body 111 is not limited to be circular. The tubular body 111 is a hollow structure with an opening in one end. The tube body 11 may be mounted on a fixing base. Specifically, the tube body 11 may be partially inserted into the fixing base. Its opening may be located in the fixing base. The pointed structure 112 is arranged at the end of the tubular body 111 away from the opening. By arranging the pointed structure 112, it is convenient for at least part of the heating structure 10 to be inserted into the aerosol forming substrate 2. In this embodiment, a first accommodating cavity 113 is formed on the inner side of the tube body 11. The first accommodating cavity 113 is a cylindrical cavity and may be non-sealed. When the heating element 12 is mounted in it, the first accommodating cavity 113 does not need to be vacuumed or filled with inert gas. It needs to be pointed out that in order to achieve better puffing taste and prolong the service life of the heating element, the open end of the tube body 11 may also be scaled. As can be understood, in some other embodiments, the heating element 12 may also be arranged on the outer periphery of the tube body 11 in a manner of being spaced apart, and a second accommodating cavity for accommodating the aerosol forming substrate 2 may be formed on the inner side of the tube body 11. In this embodiment, the tube body 11 further includes a positioning portion 114. The positioning portion 114 is arranged at the opening of the tubular body 111 and may extend radially outwards along the tubular body 111 to form a positioning flange for the mounting and positioning of the tube body 11 and the fixing base. In this embodiment, the positioning portion 114 may be integrally formed with the tubular body 111. Of course, as can be understood, in some other embodiments, the positioning portion 114 may be detachably assembled with the tube body 11 by way of sleeving, screwing, or clamping, for example. In this embodiment, a gap is provided between the inner wall of the tube body 11 and the heating element 12. The gap may be filled with air or vacuumed. By providing the gap, there can be no direct contact between the tube body 11 and the heating element 12.

By configuring the thickness of the tube wall and the spacing between the heating element 12 and the tube wall, the temperature at which the entire heating structure 10 heats the aerosol forming substrate 2 can be configured. At the same temperature, as the thickness of the tube wall increases, the overall radiance may show a decreasing trend. Further, it can ensure that as much heat as possible is generated to heat and atomize the aerosol forming substrate 2 through infrared heating, thus reducing the proportion of heat conduction that gradually heats the entire body from the surface to the inside, and achieving the effect of uniformly atomizing the aerosol forming substrate 2 on the whole. Alternatively, in some embodiments, the thickness of the tube wall of the tube body 11 is 0.15 mm-0.6 mm. Preferably, the thickness range of the tube wall of the tube body 11 is 0.15 mm-0.5 mm. In some embodiments, as the spacing between the heating element 12 and the tube wall increases, the surface temperature of the heating structure 10 may show a gradually decreasing trend. Preferably, in some embodiments, the spacing between the tube wall of the tube body 11 and the heating element 12 may be 0.05 mm-1 mm. Preferably, the spacing between the tube wall of the tube body 11 and the heating element 12 may be 0.1 mm-0.5 mm.

The highest working temperature range of the heating element 12 is 500° C.-1300° C. The highest working temperature range of the heating element 12 may also be preferably 800° C.-1100° C. At this temperature, the aerosol forming substrate 2 may be preheated in a very short time, thus ensuring rapid puffing and improving the taste of the aerosol in the first two sips when the user puffs. Specifically, in a power-on state, the heating element 12 can heat to increase the temperature up to 1000° C.-1300° C. within 1 s-3 s, the temperature at a stable heating stage can be controlled within 500° C.-800° C., and the time may be 3 minutes to 6 minutes. Of course, as can be understood, in some other embodiments, the number of the highest working temperature ranges of the heating element 12 is not limited to two. Due to the existence of the gap, the surface temperature of the tube body 11 can be controlled below 350° C., and the overall atomization temperature of the aerosol forming substrate 2 is controlled at 300° C.-350° C., thus achieving precise atomization of the aerosol forming substrate 2 in a wave band of 2 μm-5 μm.

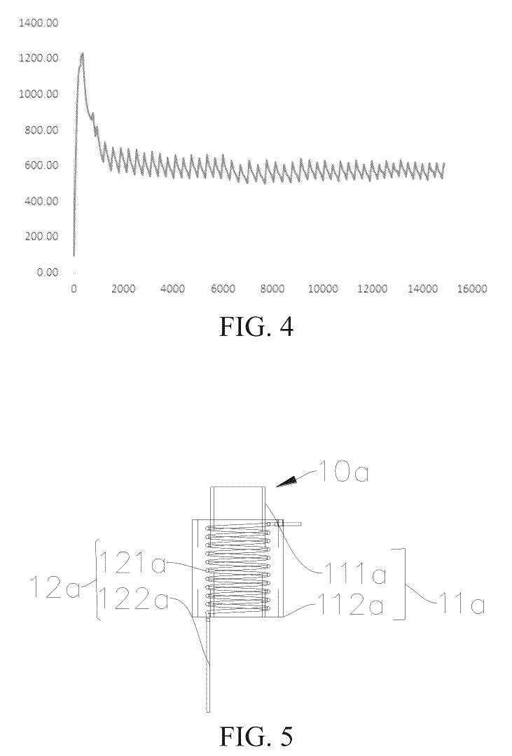

Specifically, FIG. 4 is a temperature change curve chart of the heating element 12 during working in this embodiment, where the longitudinal axis represents temperature and the horizontal axis corresponds to the number of sampling times, approximately 15 points correspond to 1 second, and a peak section represents preheating time which is approximately 1 second to 5 seconds (the output power may be controlled as needed, so that the preheating time can be selected within 1 second to 15 seconds, while it is generally more than 15 seconds in the existing technology). In this solution, the preheating time is preferably 1 second to 3 seconds. As shown in FIG. 4, after the aerosol generating device 1 is started, the heating element 12 may heat to increase the temperature up to over 1000° C. in about 1 second, that is, the first sip can be carried out in about 2 seconds. It can heat up quickly, heat up the substrate quickly, reduce waiting time, and greatly improve the consumer experience. In addition, such quick heating with temperature up to 800° C. or even over 1000° C. will not cause the substrate to be burned and influence the taste. On the contrary, the taste is improved. When the temperature reaches around 1200° C., the output power (which may be voltage) is reduced, the temperature of the heating element is lowered to around 600° C., this temperature or a small temperature pulse is maintained for 4 minutes to 5 minutes, and then the power is turned off to complete puffing. It needs to be stated that whether it is the preheating stage or the stable output stage, the main heating method is still infrared light waves. However, the infrared light wave bands corresponding to the high temperature stage and the stable output temperature are not the same, but they are both wave bands that are easily absorbed by the material.

In some embodiments, the number of the heating element 12 may be one, and may be longitudinally arranged, and may be wound to form a heating portion 121 which is spiral on the whole. Specifically, the heating element 12 may be cylindrical on the whole and may be wound to form a single-spiral structure, double-spiral structure, M-shaped structure, N-shaped structure, or structure with any other shape. Of course, as can be understood, in some other embodiments, the number of the heating element 12 is not limited to one, and may be two or more than two. In some embodiments, the heating element 12 may be formed by winding or bending a strip-shaped or linear heating wire, and may include a heating portion 121 longitudinally arranged and configured to radiate infrared light waves in a power-on state, and a conductive portion 122 configured to connect with power for the heating portion 121. In some embodiments, the heating portion 121 may include a first heating portion 1211 and a second heating portion 1212 electrically connected to each other. The first heating portion 1211 is wound around the outer side of the second heating portion 1212, and the gap is formed between the outer periphery of the first heating portion 1211 and the inner wall of the tube body. The second heating portion 1212 is linear, and the first heating portion 1211 includes at least one bent section. In some embodiments, the first heating portion 1211 may also be linear, sheetlike or tubular and any other shape, and the second heating portion 1212 may also be spiral, N-shaped, or M-shaped and any other shape. In some embodiments, the heating element 12 may include a heating substrate for generating heat in a power-on state, and an infrared radiation layer. The heating substrate may generate heat in a power-on state. The infrared radiation layer is arranged on the outer surface of the heating substrate and is configured to radiate the heat generated by the heating substrate. In this embodiment, the heating substrate and the infrared radiation layer are concentrically distributed on the cross section of the heating portion.

In this embodiment, the heating substrate may be cylindrical or linear on the whole. Specifically, the heating substrate may be a heating wire. Of course, as can be understood, in some other embodiments, the heating substrate may not be limited to be cylindrical, but may be in a sheetlike shape, that is, the heating substrate may be a heating sheet. The heating substrate includes a metal substrate with high-temperature oxidation resistance. The metal substrate may be a metal wire. Specifically, the heating substrate may be a nickel-chromium alloy substrate (such as nickel-chromium alloy wire), iron-chromium-aluminum alloy substrate (such as iron-chromium-aluminum alloy wire) or the like made of a metal material with good high-temperature oxidation resistance, high stability, and good deformation resistance. In this embodiment, the radial size of the heating substrate may be 0.15 mm-0.8 mm.

In this embodiment, the heating element 12 further includes an antioxidant layer, and the antioxidant layer is formed between the heating substrate and the infrared radiation layer. Specifically, the antioxidant layer may be an oxide film, the heating substrate undergoes high-temperature heat treatment to form a dense oxide film on its own surface, and the oxide film forms the antioxidant layer. Of course, as can be understood, in some other embodiments, the antioxidant layer is not limited to including an oxide film formed by itself. In some other embodiments, it may be an antioxidant coating layer coated on the outer surface of the heating substrate. By forming the antioxidant layer, it can ensure that the heating substrate is not or is rarely oxidized when heated in the air environment, thus improving the stability of the heating substrate. Therefore, there is no need to vacuum and fill inert gas or reducing gas into the first accommodating cavity 113, nor to seal the opening, thus simplifying the assembling process of the entire heating structure 10 and reducing the manufacturing cost. In this embodiment, the thickness of the antioxidant layer may be selectively 1 μm-150 μm. When the thickness of the antioxidant layer is less than 1 μm, the heating substrate is easily oxidized. When the thickness of the antioxidant layer is greater than 150 μm, it will influence the heat conduction between the heating substrate and the infrared radiation layer.

In this embodiment, the infrared radiation layer may be an infrared layer. The infrared layer may be an infrared layer forming substrate formed on the side of the antioxidant layer away from the heating substrate under high-temperature heat treatment. In this embodiment, the infrared layer forming substrate may be a silicon carbide, spinel, or composite substrate thereof. Of course, as can be understood, in some other embodiments, the infrared radiation layer is not limited to the infrared layer. In some other embodiments, the infrared radiation layer may be a composite infrared layer. In this embodiment, the infrared layer may be formed on the side of the antioxidant layer away from the heating substrate through dip coating, spray coating, brush coating, and other methods. The thickness of the infrared radiation layer may be 10 μm-300 μm. When the thickness of the infrared radiation layer is between 10 μm-300 μm, the thermal radiation effect is better, and the atomization efficiency and atomization taste of the aerosol forming substrate 2 are better. Of course, as can be understood, in some other embodiments, the thickness of the infrared radiation layer is not limited to 10 μm-300 μm.

In some embodiments, the heating element 12 further includes a bonding layer arranged between the antioxidant layer and the infrared radiation layer. The bonding layer may be configured to prevent the heating substrate from being broken down locally, thus further improving the bonding strength between the antioxidant layer and the infrared radiation layer. In some embodiments, the bond in the bonding layer may be glass powder, that is, the bonding layer may be a glass powder layer.

In some embodiments, the insulating sleeve 13 may be made of a ceramic or PEEK high-temperature insulating material. It may include two fixing through holes 131 provided in the insulating sleeve 13. The two fixing through holes 131 are configured to allow the conductive portions 122 of the first heating portion 1211 and the second heating portion 1212 to be inserted in.

In some embodiments, the heating structure 10 further includes a supporting rod. The supporting rod is an insulating rod. The supporting rod may partially penetrate into the heating portion 121, may be located at the center of the heating portion 121, and may be insulated from the heating portion 121. The supporting rod may play a role of supporting the heating portion 121. By arranging the supporting rod, the multiple heating portions can be supported to ensure that the heating element 12 is not completely deformed due to heating, thus ensuring that the gap between the heating element 12 and the tube body 11 is uniform so as to ensure the consistency of the temperature field. As can be understood, in some other embodiments, the supporting rod may not be arranged, but other structures may be arranged to support the heating portion 121.

FIG. 5 shows a heating structure 10a in a second embodiment of the present disclosure, the difference from the first embodiment mainly lies in that the heating structure 10a is not limited to being partially inserted into the aerosol forming substrate to heat the aerosol forming substrate. In this embodiment, the heating structure 10a may be sleeved around the outer periphery of the substrate section of the aerosol forming substrate, and adopt a circumferential heating method to heat the aerosol forming substrate.

In some embodiments, the heating structure 10a may include a tube body 11a and a heating element 12a. The heating element 12a are at least partially spaced apart from the tube wall of the tube body 11a. It is configured to generate heat in a power-on state to excite the infrared layer on the heating element 12a to emit infrared light waves. The infrared light waves pass through the tube wall of the tube body 11a and enter the aerosol forming substrate, thus heating the aerosol forming substrate. Specifically, in some embodiments, the heating element 12a may include a heating portion 121a capable of radiating infrared light waves in a power-on state, and a conductive portion 122a arranged at one end of the heating portion 121a and configured to connect with power.

In some embodiments, the tube body 11a may include a first sleeve 111a and a second sleeve 112a sleeved around the outer periphery of the first sleeve 111a; and the first sleeve 111a is a hollow structure with two ends that run through. The first sleeve 111a may be cylindrical, and its inner diameter is slightly larger than the outer diameter of the aerosol forming substrate. An interval is provided between the first sleeve 111a and the second sleeve 112a, and the interval forms an accommodating cavity for accommodating the heating element 12a; and the axial length of the first sleeve 111a may be greater than the axial length of the second sleeve 112a. The second sleeve 112a may be sleeved around the outer periphery of the first sleeve 111a. The second sleeve 112a may be cylindrical. The radial size of the second sleeve 112a may be larger than the radial size of the first sleeve 111a. In some embodiments, the heating element 12a is wound around the outer periphery of the first sleeve 111a and spaced apart from the outer wall of the second sleeve 112a, thus creating a certain temperature difference between the inner wall of the accommodating cavity and the heating element 12a to achieve the thermal insulation effect. A heating cavity for heating the aerosol forming substrate is formed on the inner side of the first sleeve 111a.

In some embodiments, the inner side of the second sleeve 112a may be provided with a reflective layer, and the reflective layer is configured to reflect the heat of the heating element 12a and radiate it to the aerosol forming substrate to enhance the heating energy efficiency. As can be understood, the first sleeve 111a and the second sleeve 112a are not limited to be cylindrical, and may also be in any other shape such as square column shape or elliptical column shape.

By configuring the thickness of the tube wall and the spacing between the heating element 12a and the tube wall, the temperature at which the entire heating structure 10a heats the aerosol forming substrate can be configured. At the same temperature, as the thickness of the tube wall increases, the overall radiance may show a decreasing trend. Further, it can ensure that as much heat as possible is generated to heat and atomize the aerosol forming substrate through infrared heating, thus reducing the proportion of heat conduction that gradually heats the entire body from the surface to the inside, and achieving the effect of uniformly atomizing the aerosol forming substrate on the whole. Alternatively, in some embodiments, the thickness of the tube wall of the first sleeve 111a is 0.15 mm-0.6 mm. Preferably, the thickness range of the tube wall of the first sleeve 111a is 0.15 mm-0.5 mm. In some embodiments, as the spacing between the heating element 12a and the tube wall of the first sleeve 111a increases, the surface temperature of the heating structure 10a may show a gradually decreasing trend. Preferably, in some embodiments, the spacing between the tube wall of the first sleeve 111a and the heating element 12a may be 0.05 mm-1 mm. Preferably, the spacing between the tube wall of the first sleeve 111a and the heating element 12a may be 0.1 mm-0.5 mm.

In some embodiments, the second sleeve 112a may further include a fixing structure, and the fixing structure is configured to fix the heating element 12a.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating structure, comprising:
a heating element; and
a tube body for infrared light waves to pass through,
wherein a gap is provided between the heating element and a tube wall of the tube body,
wherein the heating element comprises a heating portion arranged longitudinally and configured to radiate the infrared light waves in a power-on state, and a conductive portion configured to connect with power for the heating portion, and
wherein a thickness of the tube wall of the tube body is 0.1 mm-1 mm.

2. The heating structure of claim 1, wherein the heating portion comprises a heating substrate configured to generate heat in a power-on state, and an infrared radiation layer arranged on an outer surface of the heating substrate and configured to radiate the infrared light waves.

3. The heating structure of claim 1, wherein the tube body comprises quartz glass, ceramic, or diamond.

4. The heating structure of claim 1, wherein the heating portion is formed by winding or bending a strip-shaped or linear heating wire.

5. The heating structure of claim 1, wherein a thickness range of the tube wall of the tube body is 0.15 mm-0.5 mm.

6. The heating structure of claim 1, wherein a highest working temperature range of the heating element is 500° C.-1300° C.

7. The heating structure of claim 6, wherein the highest working temperature range of the heating element is 800° C.-1100° C.

8. The heating structure of claim 1, wherein a spacing of the gap is 0.05 mm-0.8 mm.

9. The heating structure of claim 8, wherein the spacing of the gap is 0.1 mm-0.5 mm.

10. The heating structure of claim 1, wherein the heating element is arranged on an inner side of the tube body, and
wherein the gap is provided between the heating element and an inner wall of the tube body.

11. The heating structure of claim 10, wherein the heating portion comprises a first heating portion and a second heating portion electrically connected to each other,
wherein the first heating portion is wound around an outer side of the second heating portion, and
wherein the gap is formed between an outer periphery of the first heating portion and the inner wall of the tube body.

12. The heating structure of claim 11, wherein the second heating portion is linear, and
wherein the first heating portion comprises at least one bent section.

13. The heating structure of claim 1, wherein the tube body comprises a first sleeve and a second sleeve sleeved around an outer periphery of the first sleeve body,
wherein an interval is provided between the first sleeve and the second sleeve, and the interval forms an accommodating cavity configured to accommodate the heating element,
wherein the heating element is arranged on an outer periphery of the first sleeve and the gap is formed between the heating element and an outer surface of the tube wall of the first sleeve,
wherein a thickness of the tube wall is a thickness of the tube wall of the first sleeve, and wherein a heating cavity configured to heat an aerosol forming substrate is formed on an inner side of the first sleeve.

14. An aerosol generating device, comprising:
the heating structure of claim 1.
